(19) United States
(12) Patent Application Publication
(10) Pub. No.: US 2018/0058223 A1
(43) Pub. Date: Mar. 1, 2018

(54) GAS TURBINE

(71) Applicant: Rolls-Royce Deutschland Ltd & Co KG, Blankenfelde-Mahlow (DE)

(72) Inventors: Knut LEHMANN, Koenigs Wusterhausen (DE); Christian KERN, Rangsdorf (DE)

(21) Appl. No.: 15/689,132

(22) Filed: Aug. 29, 2017

(30) Foreign Application Priority Data
Aug. 31, 2016 (DE) 10 2016 116 222.1

(51) Int. Cl. F01D 5/18; F01D 5/08; F01D 9/04; F01D 9/06; F23R 3/00

(52) U.S. Cl. CPC F01D 5/186; F01D 5/087; F01D 9/041; F01D 9/06; F05D 2260/202; F05D 2240/12; F05D 2240/15; F05D 2240/81; F23R 3/002

(57) ABSTRACT

A gas turbine has a combustion chamber and a turbine nozzle guide vane ring. The combustion chamber includes an outer and inner combustion chamber walls with heat shield tiles. The guide vane ring has airfoils, and outer and inner platforms. The outer and/or inner platforms form a radial step towards a main flow path such that the upstream end of the outer platform is arranged radially outside and upstream of the downstream end of the heat shield tiles of the outer combustion chamber wall, and/or the upstream end of the inner platform is arranged radially inside and upstream of the downstream end of the heat shield tiles of the inner combustion chamber wall, so that the outer platform and the heat shield tiles of the outer combustion chamber wall and/or the inner platform and heat shield tiles of the inner combustion chamber wall overlap in the axial direction.

### REFERENCE TO RELATED APPLICATION

This application claims priority to German Patent Application No. 10 2016 116 222.1 filed on Aug. 31, 2016, the entirety of which is incorporated by reference herein.

### BACKGROUND

The invention relates to a gas turbine.

The nozzle guide vanes of a nozzle guide vane ring of the stage 1 of a high-pressure turbine, which are located directly downstream of the combustion chamber of a gas turbine, are subjected to hot gases of the combustion chamber to a particularly high degree and have to be cooled at their platforms in an effective manner. The interface between the combustion chamber and the nozzle guide vane ring provides a supply possibility for cooling air. However, it can happen that the cooling air supplied through this interface intermixes with the hot gas flow of the combustion chamber due to axial and radial relative movements between the combustion chamber and the nozzle guide vane ring as they are caused by mechanical loads and different thermal expansions, leading to the disadvantage that the cooling effect is reduced.

What is known from EP 0 615 055 B1 is a nozzle guide vane cooling in which cooling air is supplied through bore holes in the outer platform of the nozzle guide vane ring.

The Invention is based on the objective to provide a gas turbine that facilitates an effective cooling of the platforms of the nozzle guide vane ring of stage 1.

### SUMMARY

An embodiment of the invention relates to a gas turbine that has a combustion chamber and a segmented turbine nozzle guide vane ring that is arranged downstream of the combustion chamber inside a main flow path, wherein the combustion chamber comprises an outer combustion chamber wall and an inner combustion chamber wall that are provided with heat shield tiles towards the combustion chamber, and the turbine nozzle guide vane ring has a plurality of nozzle guide vanes, an outer platform, and an inner platform.

It is provided that the outer platform and/or the inner platform forms a radial step towards the main flow path in such a manner that the upstream end of the outer platform is arranged radially outside and upstream of the downstream end of the heat shield tiles of the outer combustion chamber wall, and/or the upstream end of the inner platform is arranged radially inside and upstream of the downstream end of the heat shield tiles of the inner combustion chamber wall, so that the outer platform and the heat shield tiles of the outer combustion chamber wall and/or the inner platform and the heat shield tiles of the inner combustion chamber wall overlap in axial direction. Further, the gas turbine is formed in such a manner that cooling air is supplied to the nozzle guide vane ring along the radial step of the outer platform and/or along the radial step of the inner platform.

Aspects of the invention are thus based on the idea of forming the outer platform and/or the inner platform of the turbine nozzle guide vane ring with a radial step in order to realize two measures. Firstly, an overlap of the platform and the heat shield tiles of the adjacent combustion chamber wall is facilitated and provided through the radial step. As a result, the interface between the combustion chamber and the turbine nozzle guide vane ring is protected more effectively from the hot gas flow of the combustion chamber. Secondly, the radial step facilitates an effective supply of cooling air, since cooling air can be supplied in the area of the radial step and thus in parallel to the surface of the platform. Such a supply of cooling air in parallel to the surface of the platform has the effect that the cooling air can be applied to the platform in a particularly effective manner in order to provide a film cooling. In that case, the applied cooling air keeps adhered even after deflection of the platform surface.

The term “radial” relates to a symmetry axis or rotation axis of the gas turbine. If a component is arranged radially inside of another component, its radial distance to the symmetry axis is smaller than that of the other component. In contrast to that, if a component is arranged radially outside of another component, its radial distance to the symmetry axis is bigger than that of the other component.

In one embodiment of the invention, it is provided that the radial step of the outer platform and/or the radial step of the inner platform has a first, a second, and a third platform section, wherein the first platform section and the second platform section are arranged at a radial and an axial distance from each other, and the third platform section connects the first and the second platform section. Further, the first and the second platform sections are oriented essentially in axial direction compared to the third platform section that has a bigger radial directional component and thus extends inclined to the axial direction. The radial step is thus formed by an inclined extending platform section which connects two platform sections that are oriented essentially in axial direction. All three platform sections delimit the platform towards the main flow path.

Here, it is provided that the transitions between the first and the third platform section as well as between the third and the second platform section are formed without edges. The individual platform sections thus turn into each other smoothly with a continuous surface curvature. In the mathematical sense, they are differentiable at every point. When regarding the meridional section of the gas turbine, the radial step can also be referred to as the S-shaped front contour of the respective platform.

What is provided according to another embodiment of the invention are cooling holes for providing cooling air that are oriented such that cooling air is supplied to the outer platform and/or the inner platform substantially in parallel to the inclined extending platform section, and at that adjacent to the inclined extending platform section. Here, it can be provided that the cooling holes are oriented such that the angle between their longitudinal axis and a tangent at the inclined extending third platform section extending perpendicular to the circumferential direction can be less than or equal 20 degrees, in particular less than or equal 10 degrees.

Thus, cooling air is supplied via the correspondingly oriented cooling holes substantially in parallel to the third, inclined extending platform section. In this manner, it is facilitated that the cooling air can be applied very effectively at the inclined extending platform section so as to form a cooling film. Once applied, the cooling air remains adhered also in the area of the second platform section that extends in a more axial manner as compared to the third platform section. At that, the nozzle guide vanes in the second platform section are connected to the platform. Thus, an effective film cooling of the platform surfaces is provided against the hot gas flow that is discharged from the combustion chamber.

The cooling holes can be formed directly in the outer platform and/or the inner platform. According to one embodiment, the cooling holes are formed in the first platform section, and at that directly adjacent to the third platform section. In this manner, it is ensured that the cooling air ejects onto the third, inclined extending platform section directly and at the same time in a parallel orientation.

In a further embodiment of the invention, it is provided that the cooling holes are formed in such a manner that they have a substantially circular cross-section at the entry side and an elongated cross-section in the circumferential direction at their exit side. Instead of being ejected in form of individual circular cooling jets, the cooling air can thus be ejected as an almost continuously planar flow which impinges the platforms in the area of the radial step.

It can be also provided that the cooling holes are formed so as to be divergent in the circumferential direction towards the exit side with respect to the rotation or machine axis, and/or so as to be convergent towards the exit side in a direction that is normal with respect to the circumferential direction and normal with respect to the bore axis. In this manner, the effect of providing the planar flow along the radial step of the platform is even increased.

According to one embodiment of the invention, it is provided that the outer platform and/or the inner platform taper off towards the main flow path downstream of the area that is overlapping in the axial direction due to the radial step, so that the heat shield tiles of the outer combustion chamber wall and the outer platform and/or the heat shield tiles of the inner combustion chamber wall and the inner platform are aligned with each other downstream of the area that overlaps in axial direction. In this manner, an adjusted smooth surface pathway of the main flow path border is provided in the transition between the combustion chamber and the first nozzle guide vane ring of the high-pressure turbine.

It can be provided that, with the area overlapping in the axial direction, the heat shield tiles at the outer main flow path border and/or at the inner main flow path border at least partially cover a radial extending cavity between the combustion chamber and the nozzle guide vane ring. Through the axial overlapping of the heat shield tiles and the adjacent platform of the nozzle guide vane ring, the cavities between the combustion chamber and the nozzle guide vane ring are sealed in a more effective manner, and the intermixing of the hot gases of the combustion chamber with the cooling air flowing in via the cavity is reduced.

At that, it can be provided that, in the area of the gap between the combustion chamber housing and the nozzle guide vane ring, the gas turbine has a flap seal that serves for sealing the gap and that can be moved into a sealing position through a pressure of secondary air supplied for cooling, which differs from the pressure inside the main flow path.

As follows from the above explanations, it is not necessary to realize a radial step, an overlapping of the platform and the heat shield tiles, and the supply of cooling air along the radial step at the outer platform as well as at the inner platform of the nozzle guide vane ring. For example, these features according to the invention can be realized only at the outer platform. Nevertheless, it is provided in one embodiment of the invention that these features are realized at the outer platform as well as at the inner platform. In that case, it is accordingly provided that the outer platform and the heat shield tiles of the outer combustion chamber wall as well as the inner platform and the heat shield tiles of the inner combustion chamber wall overlap in the axial direction, wherein the outer platform and the inner platform form a radial step towards the main flow path, and wherein, at the downstream end of the combustion chamber, the heat shield tiles form a ring that projects into a radial opening of the nozzle guide vane ring. Here, the ring is formed by the downstream ends of the heat shield tiles of the outer combustion chamber wall and the downstream ends of the heat shield tiles of the inner combustion chamber wall, which are arranged at a radial distance from each other and form an annular space in between them.

### BRIEF DESCRIPTION OF THE DRAWINGS

The invention will be explained in more detail on the basis of exemplary embodiments with reference to the accompanying drawings in which:

FIG. 1 shows a simplified schematic sectional view of a turbofan engine in which the present invention can be realized;

FIG. 2 shows a partial view of an exemplary embodiment of a nozzle guide vane ring of the stage 1 of a high-pressure compressor, wherein the nozzle guide vane ring comprises an outer and an inner platform, and the platforms respectively form a radial step in the axially front area;

FIG. 3 shows a three-dimensional lateral rendering of a nozzle guide vane segment of the nozzle guide vane ring of FIG. 2;

FIG. 4 shows an enlarged rendering of the upper platform of the nozzle guide vane segment of FIG. 3;

FIG. 5 shows a three-dimensional rendering of the cooling holes that are formed in the upper platform of the nozzle guide vane segment according to the FIGS. 3 and 4; and

FIG. 6 shows a turbine nozzle guide vane segment of FIG. 3 in a three-dimensional view inclined from the front, or inclined with respect to the axial direction.

### DETAILED DESCRIPTION

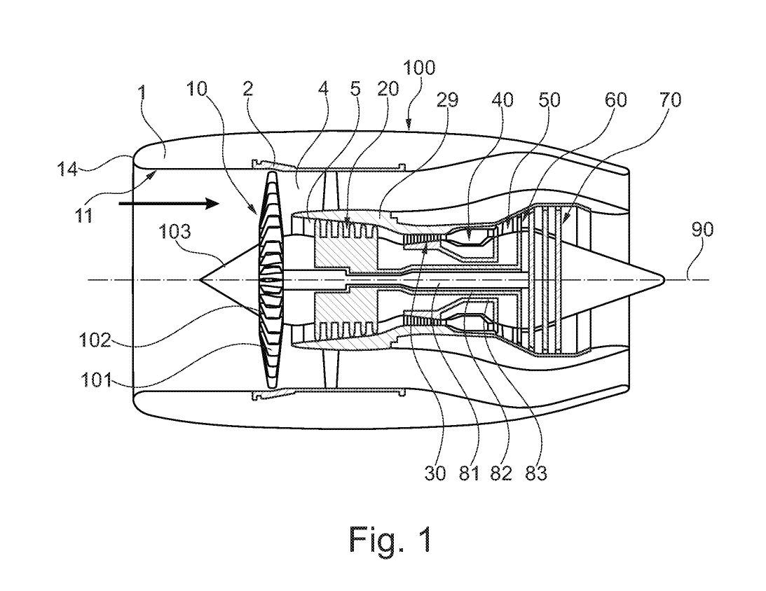

FIG. 1 shows, in a schematic manner, a turbofan engine 100 that has a fan stage with a fan 10 as the low-pressure compressor, a intermediate-pressure compressor 20, a high-pressure compressor 30, a combustion chamber 40, a high-pressure turbine 50, a intermediate-pressure turbine 60, and a low-pressure turbine 70.

The intermediate-pressure compressor 20 and the high-pressure compressor 30 respectively have a plurality of compressor stages that respectively comprise a rotor stage and a stator stage. The turbofan engine 100 of FIG. 1 further has three separate shafts, namely a low-pressure shaft 81 which connects the low-pressure turbine 70 to the fan 10, a intermediate-pressure shaft 82 which connects the intermediate-pressure turbine 60 to the intermediate-pressure compressor 20, and a high-pressure shaft 83 which connects the high-pressure turbine 50 to the high-pressure compressor 30. However, this is to be understood to be merely an example. If, for example, the turbofan engine has no intermediate-pressure compressor and no intermediate-pressure turbine, only a low-pressure shaft and a high-pressure shaft would be present.

The turbofan engine 100 has an engine nacelle 1 that comprises an inlet lip 14 and forms an engine inlet 11 at the entry side, supplying inflowing air to the fan 10. The fan 10 has a plurality of fan blades 101 that are connected to a fan disc 102. Here, the annulus of the fan disc 102 forms the radially inner boundary of the flow path through the fan 10. Radially outside, the flow path is delimited by the fan housing 2. Upstream of the fan-disc 102, a nose cone 103 is arranged.

Behind the fan 10, the turbofan engine 100 forms a secondary flow channel 4 and a primary flow channel 5. The primary flow channel 5 leads through the core engine (gas turbine) which comprises the intermediate-pressure compressor 20, the high-pressure compressor 30, the combustion chamber 40, the high-pressure turbine 50, the intermediate-pressure turbine 60, and the low-pressure turbine 70. At that, the intermediate-pressure compressor 20 and the high-pressure compressor 30 are surrounded by a circumferential housing 29 which forms an annulus surface at the internal side, delimitating the primary flow channel 5 radially outside. Radially inside, the primary flow channel 5 is delimitated by corresponding rim surfaces of the rotors and stators of the respective compressor stages, or by the hub or by elements of the corresponding drive shaft connected to the hub.

During operation of the turbofan engine 100, a primary flow flows through the primary flow channel 5 (also referred to as the main flow channel in the following). The secondary flow channel 4, which is also referred to as the partial-flow channel, sheath flow channel, or bypass duct, guides air that is drawn in by the fan 10 during operation of the turbofan engine 100 past the core engine.

The described components have a common rotation or machine axis 90. The rotation axis 90 defines the axial direction of the turbofan engine. A radial direction of the turbofan engine extends perpendicularly to the axial direction.

In the context of the present invention, the configuration of the interface between the combustion chamber 40 and the high-pressure turbine 50, in particular the embodiment of the nozzle guide vane ring of the first stage of the high-pressure turbine 50 are of importance.

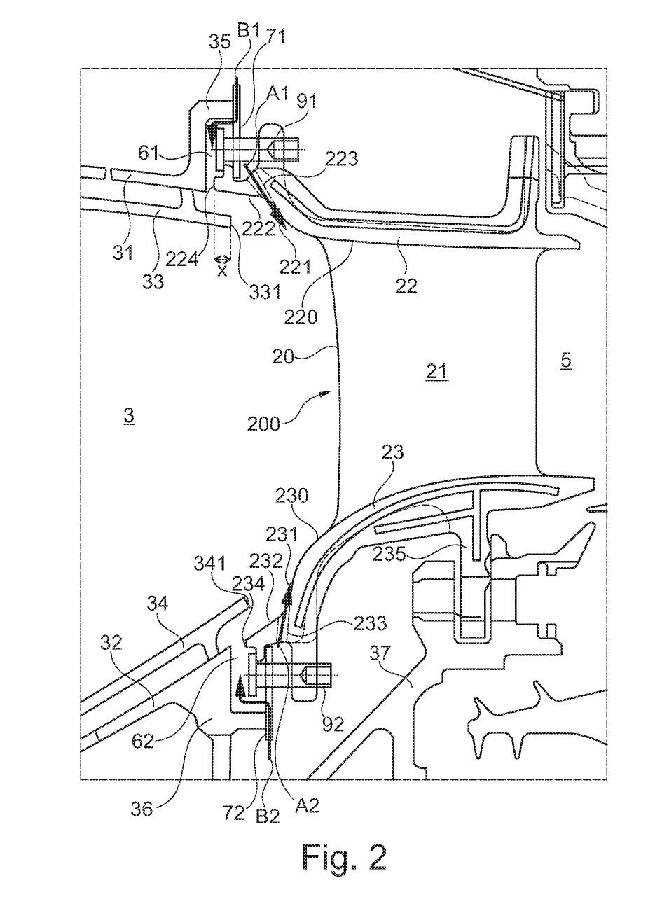

FIG. 2 shows a partial section of a main flow path 5 through a gas turbine that is part of an aircraft engine. The shown partial section shows the rear section of a combustion chamber 3—with respect to the flow direction—and a turbine nozzle guide vane segment 20 of a turbine nozzle guide vane ring 200 that is arranged directly downstream of the combustion chamber 3. The turbine nozzle guide vane ring 200 is segmented and comprises a plurality of turbine nozzle guide vane segments 20 that are arranged next to each other in the circumferential direction, thus forming the turbine nozzle guide vane ring 200 of the first stage of the high-pressure turbine.

The combustion chamber 3 comprises an outer combustion chamber wall 31 and an inner combustion chamber wall 32, wherein the terms “outer” and “inner” refer to the main flow path 5 that extends through the core engine. In order to protect it from the hot gas flow of the combustion chamber 3, the outer combustion chamber wall 31 is provided with a plurality of heat shield tiles 33 that are supported at the outer combustion chamber wall 31 and are attached at the same by means of bolts (not shown), for example. The heat shield tiles 33 are arranged in front of the outer combustion chamber wall 31 with respect to the interior of the combustion chamber. In a corresponding manner, the inner combustion chamber wall 32 is also provided with a plurality of heat shield tiles 34 that are supported at the inner combustion chamber wall 32 and are attached at the same by means of bolts (not shown), for example. The heat shield tiles 33 are arranged in front of the outer combustion chamber wall 32 with respect to the interior of the combustion chamber.

The outer combustion chamber wall 31 forms a part of an outer combustion chamber housing, of which a further wall structure 35 is shown. The outer combustion chamber housing comprises further wall structures that are not shown in FIG. 2. The inner combustion chamber wall 32 forms a part of an inner combustion chamber housing that also comprises further wall structures, of which two further wall structures 36, 37 are shown.

Each turbine nozzle guide vane segment 20 of the turbine nozzle guide vane ring 200 comprises at least one aerofoil 21, an outer platform 22 that delimits the main flow path 5 radially outside, and an inner platform 23 that delimits the main flow path 5 radially inside. The outer platforms 22 of the turbine nozzle guide vane segments 20 and the inner platforms 23 of the turbine nozzle guide vane segments 20 form an outer platform and an inner platform of the nozzle guide vane ring 200.

A turbine nozzle guide vane segment 20 can comprise one or multiple aerofoil 21 that are arranged at a distance from each other in the circumferential direction. Principally, it can also be provided that the turbine nozzle guide vane segments have aerofoils with a tandem design.

The turbine nozzle guide vane segments 20 are attached at the inner combustion chamber housing. For this purpose, the inner platform 23 forms a substantially radially extending wall 235 that is attached inside a recess at the wall structure 37 of the inner combustion chamber housing. Here, this kind of fixing of the nozzle guide vane segments 20 is to be understood merely by way of example.

At the outer platform 22, the nozzle guide vane segments 20 and thus also the entire nozzle guide vane ring 200 form three platform sections towards the main flow path 5 in the upstream area that is facing towards the combustion chamber 3, with the platform sections delimiting the main flow path 5 radially outside. What is thus provided is a first platform section 222, with its upstream end 224 representing the upstream boundary of the nozzle guide vane segment 20 in the area of the upper platform 22. A second platform section 220 is arranged at a radial as well as an axial distance to the first platform section 222. In the area of the second platform section 220, the nozzle guide vane 21 is connected to the outer platform 22. The surfaces of the second platform section 220 are directly exposed to the hot gas flow of the combustion chamber 3.

The first platform section 222 and the second platform section 220 are connected to each other by a third platform section 221. The first platform section 222 and the second platform section 220 extend at least approximately in the axial direction. In contrast, the third platform section 221 has a larger radial directional component, so that it extends more inclined with respect to the axial direction. The first platform section 222 and the third platform section 221 are formed upstream of the leading edges of the aerofoils 21. The transition between the individual platform sections is free of any edges. Instead, a smooth transition is present between the individual sections 222, 221, 220. In the mathematical sense, the transitions between the platform sections 222, 221, 220 are differentiable.

In a corresponding manner, the inner platform 23 also forms three platform sections towards the main flow path 5 in the axially front area that is facing towards the combustion chamber 3, with the platform sections delimiting the main flow path radially. What is provided is a first platform section 232, with its upstream end 324 representing the upstream boundary of the nozzle guide vane segment 20 in the area of the lower platform 23. A second platform section 230 is arranged at a radial as well as at an axial distance to the first platform section 232. The aerofoil 21 is connected to the platform 23 in the area of the second platform section 230.

The first platform section 232 and the second platform section 230 are connected to each other by means of a third platform section 231. The first platform section 232 and the second platform section 230 extend at least approximately in the axial direction. In contrast to that, the third platform section 231 has a larger radial directional component, so that it extends more inclined with respect to the axial direction. The first platform section 232 and the third platform section 231 are formed upstream of the leading edges of the aerofoil 21. The transition between the individual platform sections is free of any edges. What is present is a smooth transition between the individual sections 232, 231, 230. In the mathematical sense, the transitions between the platform sections 232, 231, 220 are differentiable.

Respectively one radial step is realized by means of the three platform sections of the outer platform 22 and the inner platform 23 insofar as the platform sections 222, 220 and 232, 230 are arranged at a radial distance to each other. Here, the two first platform sections 222, 232 form an enlarged opening mouth of the nozzle guide vane segment 20 towards the combustion chamber 3.

Further, it is provided that, in the area of the first platform sections 222, 232, cooling holes 223, 233 are formed inside the first platform section 222, 232. At that, the cooling holes 223, 233 are formed in the first platform section 222, 232 directly adjacent to the third platform section 221, 231. They are oriented in such a manner that the cooling air that is supplied via the cooling holes 223, 233 ejects substantially in parallel to the inclined extending third platform section 221, 231, and at that adjacent at this platform section 221, 231.

The cooling air that ejects through the cooling holes 223, 233 is shown in a schematic manner by A1, A2.

By blowing in the cooling air in parallel to the third platform sections 221, 231, it is achieved that the cooling air is applied at the wall in an effective manner, forming a cooling film at the same. Here, the applied cooling film remains adhered as the cooling film changes its direction in the transition to the second platform section 220, 230. The cooling film forms a thermal shield of the platforms 22, 23 against the hot gas flow that is discharged from the combustion chamber 3.

The turbine nozzle guide vane segments 20 are suspended inside a housing structure. In principle, the suspension can be realized at the combustion chamber housing or at the outer housing of the high-pressure turbine. In any case, an interface is present between the nozzle guide vane segment 20 and the combustion chamber 3. Radially outside as well as radially inside, this interface comprises a gap 61, 62 that extends substantially in the radial direction. Thus, a gap 61 extends between the outer platform 22 of the nozzle guide vane segment 20 and the wall structure 35 of the outer combustion chamber housing. A gap 62 also extends between the inner platform 23 of the nozzle guide vane segment 20 and the wall structure 36 of the inner combustion chamber housing. The gaps 61, 62 result from the suspension of the nozzle guide vane segments 20 and are necessary for compensating for relative movements and tolerances that may occur.

It has to be avoided that hot gases of the combustion chamber 3 enter the gap 61, 62. In order to prevent this, a further cooling air flow B1, B2 can be provided, which is shown in a schematic manner in FIG. 2. Further, a flap seal with flaps 71, 72 and retaining bolts 91, 92 can be provided, which serves for sealing the gaps 61, 62, wherein the flaps 71, 72 can be tilted into a sealing position by means of differing pressures in the main flow path 5 and in the further cooling air flow B1, B2.

Due to the configuration of the outer platform 22 with a radial step at the upstream end, the present invention facilitates a further measure by means of which the hot gases are prevented from entering from the combustion chamber 3 into the respective gap 61, 62. In this manner, it is provided that the upstream end 224 of the outer platform 22 is arranged radially outside and upstream of the downstream end 231 of the heat shield tiles 33 of the outer combustion chamber wall 31. At that, the heat shield tiles 33, 34 delimit the main flow path in the area of the combustion chamber 3.

Further, it can be provided that the upstream end 234 of the inner platform 23 is arranged radially inside and upstream of the downstream end 241 of the heat shield tiles 34 of the inner combustion chamber wall 32.

As a result, the outer platform 22—namely its first platform section 222—and the heat shield tiles 33 of the outer combustion chamber wall 31 overlap in the axial direction. This is shown in a schematic manner in FIG. 2. The axial overlap is indicated by x. Further, the inner platform 23—namely its first platform section 232—and the heat shield tiles 34 of the inner combustion chamber wall 32 overlap in the axial direction. Due to the axial overlap it is either avoided that hot gases of the combustion chamber 3 can flow into the respective gap 61, 62, or at least it is achieved that this occurs only to a limited extent.

Upstream, the nozzle guide vane segment 20 thus forms an enlarged entry opening through the first platform sections 222, 232 into which the heat shield tiles 33, 34 project, forming an axial overlapping x. At that, the heat shield tiles 33, 34 form the discharge opening of the combustion chamber 3 with their downstream ends 331, 341.

The described axial overlap can be realized only in the area of the upper platform 22, only in the area of the lower platform 23, or in the area of both platforms 22, 23.

It is to be understood that, as a result of the outer platform 22 tapering off towards the main flow path 5 due to the radial step that is formed by the platform sections 222, 221, 220, it is achieved that the heat shield tiles 33 and the outer platform 22, namely the second platform section 220, are aligned with each other. Downstream of the overlapping area x, the radially outer boundary of the main flow path 5 is thus provided with an adjusted smooth surface course that is free of any radial jumps. The larger the overlap, the better the homogeneity of the main flow path border, and the less hot gases can enter the gap 61.

This correspondingly applies to the boundary of the main flow path 5 at the radially inner platform 23.

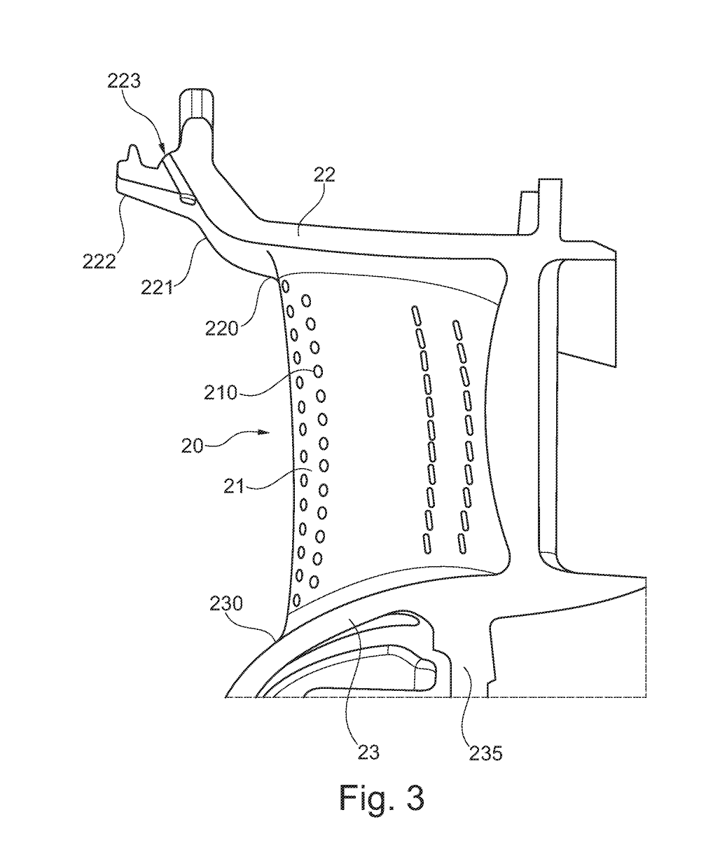

The three-dimensional rendering of FIG. 3 of a turbine nozzle guide vane segment 20 shows the outer platform 22, the platform sections 222, 221, 220, and the cooling holes 223 that are oriented in parallel to the third (middle) platform section 221 and at that are formed in the first platform section 222 directly adjacent to the third platform section 221.

As for the inner platform 23, only the second platform section 230 as well as the radially extending wall 235 can be seen. In addition to the rendering of FIG. 2, the cooling holes 210 of the nozzle guide vane 20 are shown. However, they are not relevant in the context of the present invention.

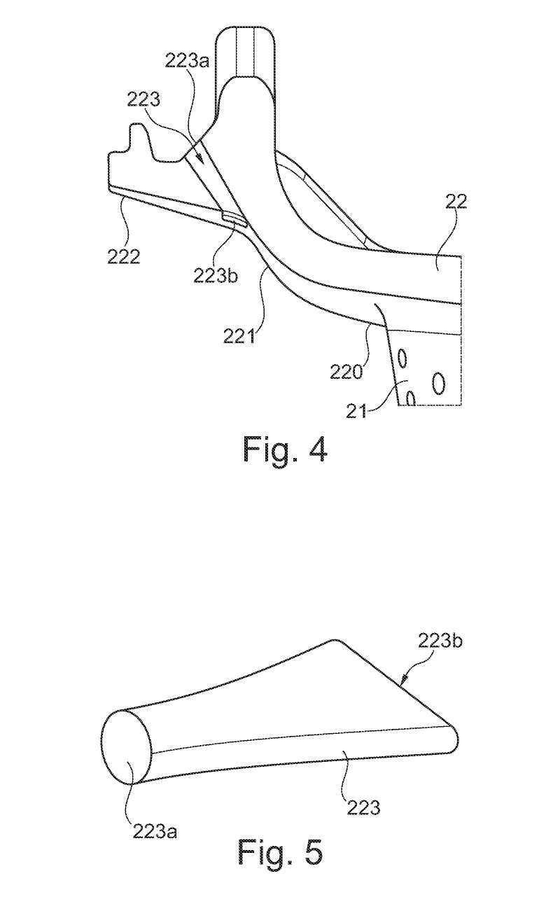

FIG. 4 is an enlarged rendering of the upstream end of the outer platform 22 of a turbine nozzle guide vane segment according to FIGS. 2 and 3. Again, what can be seen are the platform sections 222, 221, 220, and the cooling holes 223 that are oriented so as to be in parallel to the third platform section 221, and at that are formed in the first platform section 222 directly adjacent to the third platform section 221. The cooling holes 223 have an entry side 223a and an exit side 223b.

Here, it can be provided that the cooling holes 223 extend between the entry side 223a and the exit side 223b according to the embodiment of FIG. 5. Accordingly, a cooling hole 223 has a substantially circular cross-section at its entry side 223a. It changes in the direction of the exit side 223b, turning into an elongated cross-section. At the same time, the cooling hole 223 diverges in the circumferential direction towards the exit side 223b. The cooling hole 223 converges towards the exit side 223b in a direction that is normal with respect to the circumferential direction and normal with respect to the borehole axis. In this manner, it is achieved that the third platform section 221 is impinged by a flow that is substantially continuous in the circumferential direction while at the same time being planar. In this manner, it is ensured that a cooling film is applied to all surfaces of the third platform section 221.

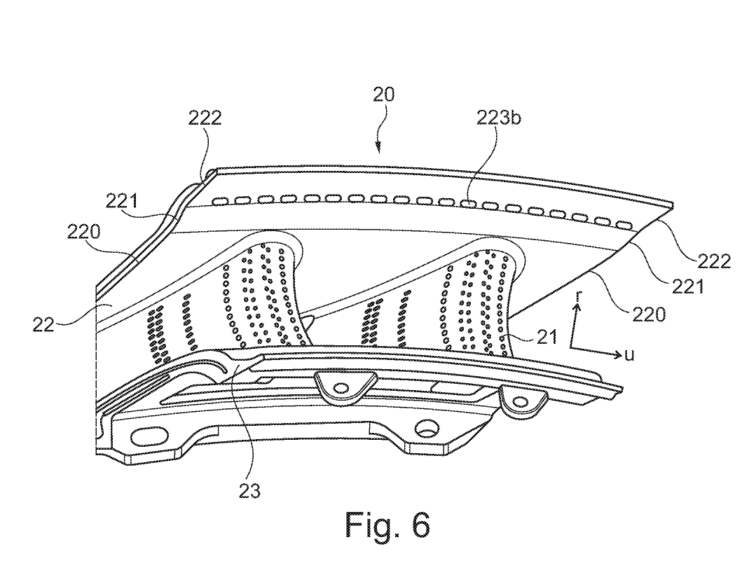

FIG. 6 shows a turbine nozzle guide vane segment 20 in a perspective rendering inclined from the front. The shown nozzle guide vane segment 20 has two aerofoils 21. What can be seen in the area of the outer platform 22 are the exit sides 223b of the cooling holes formed directly adjacent to the third, inclined extending platform section 221 that connects the first platform section 222 and the second platform section 220 to each other.

As for its embodiment, the present invention is not limited to the above described exemplary embodiments. For example, additional cooling holes to cool the outer platform and the inner platform of the nozzle guide vane segments can be provided. It is to be understood that in alternative exemplary embodiments, which are not shown, only the outer platform 22 or only the inner platform 23 is provided with three platform sections that form a radial step.

It is also to be understood that the features of the individual described exemplary embodiments of the invention can be combined with each other in different combinations. As far as ranges are defined, they comprise all values within these areas as well as all partial areas falling within an area.

1. A gas turbine, comprising inside a main flow path:
a combustion chamber that comprises an outer combustion chamber wall and an inner combustion chamber wall, which are provided with heat shield tiles towards the combustion chamber, and
a segmented turbine nozzle guide vane ring that is arranged downstream of the combustion chamber and that has a plurality of aerofoils, an outer platform, and an inner platform,
wherein
the outer platform and/or the inner platform form a radial step towards the main flow path in such a manner that the upstream end of the outer platform is arranged radially outside and upstream of the downstream end of the heat shield tiles of the outer combustion chamber wall, and/or the upstream end of the inner platform is arranged radially inside and upstream of the downstream end of the heat shield tiles of the inner combustion chamber wall, so that the outer platform and the heat shield tiles of the outer combustion chamber wall and/or the inner platform and the heat shield tiles of the inner combustion chamber wall overlap in the axial direction, and
the gas turbine is formed in such a manner that cooling air is supplied to the nozzle guide vane ring along the radial step of the outer platform and/or along the radial step of the inner platform.

2. The gas turbine according to claim 1, wherein the radial step of the outer platform and/or the radial step of the inner platform has a first, a second and a third platform section, wherein the first platform section and the second platform section are arranged at a radial and an axial distance from each other, the third platform section connects the first platform section and the second platform section, and the first and the second platform sections are oriented essentially in axial direction compared to the third platform section that has a larger radial directional component and extends inclined to the axial direction, and wherein the transitions between the first and the third platform section and between the third and the second platform section are formed without any edges.

3. The gas turbine according to claim 2, further comprising cooling holes that are oriented such that the outer platform and/or the inner platform is supplied with cooling air substantially in parallel to the inclined extending platform section, and at that adjacent to the inclined extending platform section.

4. The gas turbine according to claim 3, wherein the cooling holes are oriented such that the angle between their longitudinal axis and a tangent at the inclined extending third platform section that is extending perpendicular to the circumferential direction is less or equal 20 degrees, in particular less or equal 10 degrees.

5. The gas turbine according to claim 3, wherein the cooling holes are formed in the outer platform and/or in the inner platform.

6. The gas turbine according to claim 5, wherein the cooling holes are formed in the first platform section, and there directly adjacent to the third platform section.

7. Gas turbine according to claim 3, wherein the cooling holes are formed such that they have a substantially circular cross-section at their entry side, and an elongated cross-section at their exit side.

8. Gas turbine according to claim 3, wherein the cooling holes are formed so as to be divergent towards the exit side in the circumferential direction with respect to the rotation axis.

9. Gas turbine according to claim 3, wherein the cooling holes are formed so as to be convergent towards the exit side in a direction that is normal with respect to the circumferential direction and normal with respect to the bore axis.

10. Gas turbine according to claim 1, wherein the outer platform and/or the inner platform taper off towards the main flow path downstream of the area that overlaps in axial direction due to the radial step, so that the heat shield tiles of the outer combustion chamber wall and the outer platform and/or the heat shield tiles of the inner combustion chamber wall and the inner platform are aligned to each other downstream of the area that overlaps in axial direction.

11. Gas turbine according to claim 1, wherein, with the area that overlaps in axial direction, the heat shield tiles at the outer main flow path border and/or at the inner main flow path border axially cover a gap, which extends radially between the combustion chamber and the nozzle guide vane ring, at least partially.

12. The gas turbine according to claim 11, wherein, in the area of the gap, the gas turbine has a flap seal that serves for sealing the gap and can be moved into a sealing position through a differing pressure of the secondary air supplied for cooling with respect to a pressure inside the main flow path.

13. The gas turbine according to claim 1, wherein the outer platform and the heat shield tiles of the outer combustion chamber wall as well as the inner platform and the heat shield tiles of the inner combustion chamber wall overlap in the axial direction, wherein the outer platform as well as the inner platform form a radial step towards the main flow path, and wherein the heat shield tiles form a ring at the downstream end of the combustion chamber, which projects into the radial opening of the nozzle guide vane ring.

14. The gas turbine, comprising inside a main flow path:
a combustion chamber that comprises an outer combustion chamber wall and an inner combustion chamber wall, which are provided with heat shield tiles towards the combustion chamber, and
a segmented turbine nozzle guide vane ring that is arranged downstream of the combustion chamber and that has a plurality of aerofoils (21), an outer platform, and an inner platform,
wherein the outer platform and/or the inner platform form a radial step towards the main flow path in such a manner that the upstream end of the outer platform is arranged radially outside and upstream of the downstream end of the heat shield tiles of the outer combustion chamber wall, and/or the upstream end of the inner platform is arranged radially inside and upstream of the downstream end of the heat shield tiles of the inner combustion chamber wall, so that the outer platform and the heat shield tiles of the outer combustion chamber wall and/or the inner platform and the heat shield tiles of the inner combustion chamber wall overlap in the axial direction,
wherein the radial step of the outer platform and/or the radial step of the inner platform has a first, a second and a third platform section, wherein the first platform section and the second platform section are arranged at a radial and an axial distance from each other, the third platform section connects the first platform section and the second platform section, and the first and second platform section are oriented essentially in axial direction compared to the third platform section, which has a larger radial directional component and extends inclined to the axial direction,
wherein the transitions between the first and the third platform section and between the third and the second platform section are formed without any edges, and
the gas turbine has cooling holes at the outer platform and/or the inner platform that are oriented such that cooling air is supplied to the outer platform and/or the inner platform substantially in parallel to the inclined extending platform section, and at that adjacent at the inclined extending platform section.

15. The gas turbine according to claim 14, wherein the cooling holes are formed in the first platform section, and there directly adjacent to the third platform section.
